(19) United States
(12) Patent Application Publication
(10) Pub. No.: US 2001/0030152 A1
(43) Pub. Date: Oct. 18, 2001

(54) Compound mixer and filter for lapping machine

(76) Inventors: David A. Wright, Victor, NY (US); William D. McGlasson, Caledonia, NY (US); James J. Gnadt, Fairport, NY (US); William J. D'Angelo, Geneseo, NY (US)

Correspondence Address: Robert L. McDowell, The Gleason Works, 1000 University Avenue, P.O. Box 22970, Rochester, NY, 14692-2970, US

(21) Appl. No.: 09/731,444

(22) Filed: Dec. 7, 2000

Related U.S. Application Data
(60) Provisional application No. 60/172,757, filed on Dec. 20, 1999.

(51) Int. Cl. B03C 1/02; B01F 9/10; B24B 37/00

(52) U.S. Cl. 210/171; 210/222; 366/221; 451/442

(57) ABSTRACT

A lapping compound holding tank (60) positionable at least partially below the lapping chamber of a lapping machine. The cylindrical tank is rotatable about its axis and includes a fixed mixer and scraping assembly (80) positioned in the tank. The mixer and scraping assembly provides strong small-scale turbulence or even scraping action very close to the bottom (64) of the tank. The tank configuration enables efficient use of floor space since the tank occupies much of the same area as the lapping chamber of the machine. There are fewer potential accumulation surfaces between the lapping chamber drain and the tank. Cost and complexity of the tank is reduced. The present invention also includes an in-line compound filtration system (120) comprising an inlet section (122), a funnel portion (128) having a tubular portion (130) and an outlet (132), and a removable magnetic unit (134) having a cylindrical magnet (136). The magnetic unit is positioned in the funnel section so that the magnet resides in the tubular section formed by the tubular portion and the inlet section. Lapping compound enters inlet section, passes along the magnet where any entrained metal particles are deposited, and exits via the outlet. The magnet is periodically removed for cleaning.

This application claims the benefit of U.S. Provisional Application No. 60/172,757 filed Dec. 20, 1999.

### FIELD OF THE INVENTION

The present invention is directed to a lapping compound mixing apparatus and magnetic separator for a lapping machine, specifically a machine for lapping bevel and hypoid gears.

### BACKGROUND OF THE INVENTION

Lapping is a well established process for finishing the tooth surfaces of bevel gears. It is a process that provides an economical alternative to other hard finishing processes for bevel gears and it has been used in all areas except for some aircraft applications.

Lapping is a process wherein fine abrasive particles suspended in a carrier substance are utilized to abrade the surface of a workpiece. In the gear finishing process of lapping, an abrasive mixture, referred to as lapping compound, is introduced to the meshing tooth surfaces of two gears under load conditions. Lapping compound typically consists of an abrasive grit (such as silicon carbide) mixed into an oil or other fluid carrier medium. Lapping compounds are available pre-mixed commercially or can be mixed by the user. The abrasive grits can consist of any suitable hard, abrasive substance, commonly available according to grain size. Fluid mediums can be oil-based, water-based, water-soluble oils, and others.

In the lapping process, a pinion and ring gear are mounted, via appropriate workholding equipment, to respective spindles in the lapping machine. In most instances of rolling of the gearset, the pinion is the driving member and the ring gear is braked. The gears are rolled in mesh as the lapping compound is poured into the meshing zone. Examples of lapping machines can be found in U.S. Pat. No. 3,099,901 to Hunkeler; U.S. Pat. No. 3,142,940 to Rebeski; U.S. Pat. No. 3,717,958 to Ellwanger et al.; U.S. Pat. No. 5,609,058 to Gnadt et al. and U.S. Pat. No. 6,120,355 to Stadtfeld et al.

Most lapping machines have three degrees of freedom available for realizing relative motion between members of a gearset such as a ring gear and pinion. In lapping processes, relative movement between members of a gearset effect positional changes in the contact pattern of the members, in effect modifying the contact pattern. Lapping involves rotating the gear members in mesh with contact at a desired position on the tooth surfaces. As the gearset is lapped, contact is shifted toward one of the outer (heel) or inner (toe) portions of the tooth. When the desired heel or toe position is reached, contact is shifted to the other of the heel or toe.

The application of the lapping compound is usually through nozzles near the meshing point of the teeth with the flow rate, pressure, temperature and consistency of the compound being significant factors in the effectiveness of the delivery system. Examples of nozzle delivery system are shown in U.S. Pat. No. 2,541,283 to Praeg; U.S. Pat. No. 5,538,462 to Gnadt and previously mentioned U.S. Pat. No. 6,120,355 to Stadffeld et al.

A primary factor in the successful application of lapping compound is to effectively control the consistency of the mixture. This involves mixing the compound to keep the abrasives in suspension with the oil or other fluid, countering the tendency of the abrasives to settle out of the medium. Should the abrasive grit fall out of suspension, problems can occur such as (1) the lapping process can be adversely affected if an insufficient amount of grit is suspended in the medium, and (2) the sedimented grit can accumulate on machine surfaces or obstruct paths of flow. Additionally, the sharp and irregular grains of accumulated sediment can over a matter of time settle into and become interlocked with each other, becoming very thick, difficult to remove, and hard to reintroduce into suspension.

U.S. Pat. No. 2,691,250 to McMullen et al. teach a lapping compound mixing and delivery system comprising a mixing tank having two paddle wheels. The tank is connected, via a trap, to a pump for providing lapping compound to the lapping chamber. The trap is intended to prevent abrasive material that settles out of suspension, during times when the machine is not operating, from entering the pump.

The matter of particles settling out of suspension during times of no machine operation is discussed in U.S. Pat. No. 4,513,894 to Doyle et al. A supply system for delivering abrasive slurry to a polishing or grinding machine for metallurgical specimens includes a valve to direct the abrasive slurry back into the holding tank to assist in mixing the abrasive slurry when the machine is not operating. However, injecting compound at the top of the tank produces little mixing action. Furthermore, Doyle et al. disclose a sharp-cornered, flat bottom tank. In tanks with corners and flat bottoms, particles have a tendency to settle in the corners at the tank bottom and Doyle et al. teach no significant means to effect a complete mixing action to keep all abrasive particles in suspension in the tank.

In the previously mentioned U.S. Pat. No. 5,538,462 to Gnadt, a lapping compound mixing and supply system is disclosed wherein lapping compound is recirculated to the mixing vessel when not supplied to the lapping chamber of a machine tool such as a gear lapping machine. Lapping compound is pumped at about a first range of pump speeds to the lapping chamber, however, when no lapping is being performed, lapping compound is pumped at a second, decreased range of pump speeds through a recirculating conduit and introduced into the mixing vessel along the conical bottom surface of the vessel. The introduction of lapping compound in this manner, along with the action of an rotating impeller in the vessel, provides improved mixing of the lapping compound and homogenizes the temperature thereof.

As discussed above, mixing of the lapping compound has been attempted by agitation (inserting motor-driven rotating mixing vanes into a stationary tank), by recirculation (circulating the lapping compound through a pump and back to a tank), or a combination of the two. Pumps that have been employed include air-driven diaphragm pumps, electric motor-driven centrifugal pumps, etc. Stirring vanes have been designed to function roughly like propeller blades.

The above systems have exhibited problems and limitations in their effectiveness, service-life, cost, and maintainability. For instance, recirculation alone generally lacks the vigor to restore deposited sediments to suspension.

Also, the motorized mixing vanes that have been employed have attempted to introduce sufficient turbulence and currents into the fluid within the holding tank so as to deprive the grit of an opportunity to settle to the bottom of the tank. Typical rotational speeds of the vanes have been about 90 RPM. Practice has shown, however, that even when the stirring vanes are in continuous operation, settling does occur within the tank. As soon as stirring stops for any extended period, the inevitable sediments that accumulate cannot be successfully reintroduced into the medium by the agitation alone. A person must periodically scrape the accumulation from the tank bottom.

If the stirring is not performed for more than a few days, the mixing vanes themselves, located close to the tank bottom, can get “cemented” into the accumulated grit. The sediment becomes so solid that the electric motor cannot break them free, and the propeller vanes can be inadvertently bent when trying to remove them. Simple motors can burn out with excessive internal currents and heat if they are locked from turning. Because the vanes are designed as propellers, they have angled surfaces that present a relatively large area when viewed from the top. This provides the grit a large opportunity to cement-in the blades. For example, with a typical 0.25 horsepower motor and appropriate gearing, mixing vanes turning at 90 RPM can generate only 58 foot-pounds (ft.-lbs.) of rated torque which is not sufficient for the vanes to break-free from their cemented-in condition.

In an attempt to encourage the sediment to gravitate to the center of circular tanks, an expensive-to-manufacture sloped (conical) bottom has been employed. This measure is taken because it is known that the agitation of stirring becomes much less effective towards the outer wall of the tank. The effectiveness of this shape is questionable, however, given the extent of accumulation observed around the perimeter of such tanks. The motor in such designs is required to be located on the top center of the tank, and can lead to a relatively tall space requirement for the system. The tank, therefore, is often located some distance away from the lapping chamber, forcing the resulting angled gravity-return path to be a potential accumulation zone. Sealing the bearings that support the mixing and motor shafts against contamination with lapping compound is also difficult in such designs.

Another important factor in the successful application of lapping compound is to effectively prevent metal chips from finding their way into the lapping compound. In some instances, workpieces, especially gears, are not chamfered to remove burrs after cutting. When such workpieces are heat treated, burrs that are present become very hard and sharp. These burrs are removed from the workpiece by the lapping process and subsequently make their way through the compound supply system causing damage to the pump, especially to diaphragms which are easily punctured, clogging the valves and piping system, or, ruining other workpieces by being reintroduced into the lapping chamber along with the lapping compound.

### SUMMARY OF THE INVENTION

The present invention comprises a lapping compound holding tank positionable at least partially below the lapping chamber of a lapping machine. The cylindrical tank is rotatable about its axis and includes a fixed mixer and scraping assembly positioned in the tank. The mixer and scraping assembly provides strong small-scale turbulence or even scraping action very close to the bottom of the tank. The tank configuration enables efficient use of floor space since the tank occupies much of the same area as the lapping chamber of the machine. There are fewer potential accumulation surfaces between the lapping chamber drain and the tank. Cost and complexity of the tank is reduced.

The present invention also includes an in-line compound filtration system comprising an inlet section, a funnel portion having a tubular portion and an outlet, and a removable magnetic unit having a cylindrical magnet. The magnetic unit is positioned in the funnel section so that magnet resides in the tubular section formed by the tubular portion and the inlet section. Lapping compound enters inlet section, passes along the magnet where any entrained metal particles are deposited, and exits via the outlet. The magnet is periodically removed for cleaning.

### BRIEF DESCRIPTION OF THE DRAWINGS

FIG. 1 schematically illustrates a known lapping machine.

FIG. 2 shows a top view of the spindle arrangement of the machine of FIG. 1.

FIG. 3 is a top view of the inventive compound mixing tank.

FIG. 4 illustrates the mixer and scraping assembly of the present invention.

FIG. 5 is an elevated view of the mixing tank positioned under the lapping chamber.

FIG. 6 is a top view of the mixing tank positioned under the lapping chamber.

FIG. 7 illustrates the magnetic filtration assembly of the present invention.

FIG. 8 illustrates the cleaning apparatus for the magnetic unit of the filtration assembly

FIG. 9 diagrammatically illustrates a compound circulation system.

### DETAILED DESCRIPTION OF THE PREFERRED EMBODIMENT

The details of the present invention will now be discussed with reference to the accompanying drawings.

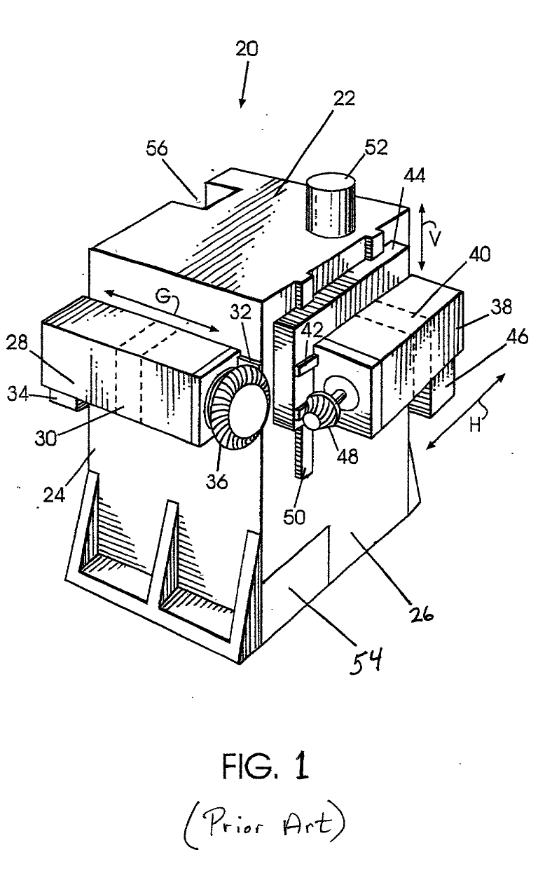

FIG. 1 illustrates a lapping machine designated generally by 20. Such a lapping machine being of the type as disclosed in previously mentioned U.S. Pat. No. 6,120,355. For ease in viewing the various machine components, FIG. 1 illustrates the machine 20 without doors and exterior sheet metal. The machine 20 comprises a single column 22 that may also be thought of as the machine frame. Column 22 comprises at least three sides, preferably four sides, with at least two of the sides, first side 24 and second side 26, being perpendicular to one another. Each of the first and second sides comprises a width and a height (as viewed in FIG. 1).

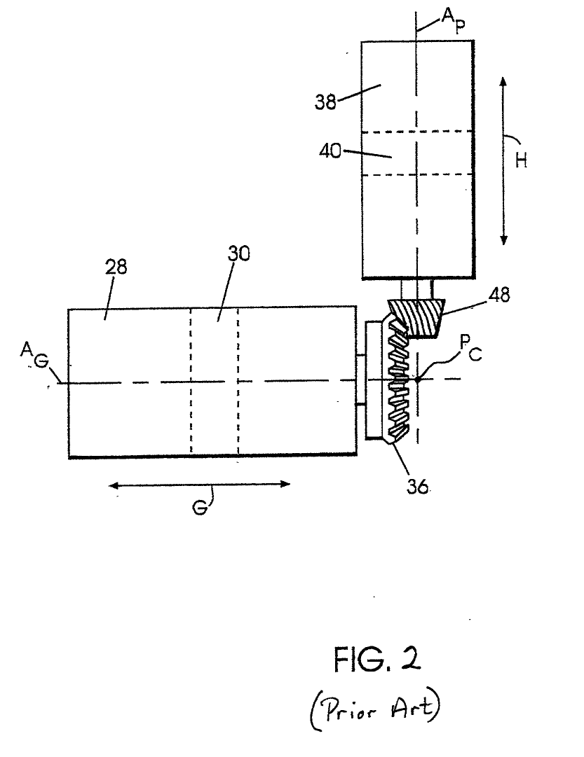

First side 24 includes first workpiece spindle 28 which is rotatable about axis A_{G} (FIG. 2) and is preferably driven by a direct drive motor 30 mounted between front and rear spindle bearings (not shown). Spindle 28 is movable along the width of first side 24 in direction G on ways 32 attached directly to column 22. Movement of spindle 28 in direction G is provided by motor 34 through a direct-coupled ballscrew (not shown). Preferably, a bevel ring gear member 36 is releasably mounted to spindle 28 by suitable workholding equipment as is known in the art.

Second side 26 includes second workpiece spindle 38 which is rotatable about axis A_{P} (FIG. 2) and is preferably driven by a direct drive motor 40 mounted between front and rear spindle bearings (not shown) with motor 40 capable of attaining a pinion rotation of about 4000 RPM (the RPM of motor 30 would be: pinion RPM/ratio of the gearset).

Spindle 38 is movable along the width of second side 26 in direction H on ways 42 attached to slide 44. Movement of spindle 38 in direction H is provided by motor 46 through a direct-coupled ballscrew (not shown). Preferably, a pinion member 48 is releasably mounted to spindle 38 by suitable workholding equipment as is known in the art. Workpiece spindle 38 is also movable along the height of second side 26 in direction V since slide 44 is movable in the V direction via ways 50 with movement being provided by motor 52 through a direct-coupled ballscrew (not shown). Directions G, H and V are mutually perpendicular with respect to one another. For practical purposes as well as for purposes of illustration, in FIG. 1, the V direction is vertical.

Movement of first work spindle 28 in direction G, second work spindle 38 in direction H, slide 44 in direction V, as well as first spindle rotation and second spindle rotation, is imparted by the separate drive motors 34, 46, 52, 30 and 40 respectively. The above-named components are capable of independent movement with respect to one another or may move simultaneously with one another. Each of the respective motors is associated a feedback device such as a linear or rotary encoder (not shown) as part of a CNC system which governs the operation of the drive motors in accordance with instructions input to a computer controller such as the Fanuc model 160i.

A tank for holding lapping compound is placed generally under the work chamber area adjacent to second side 26 as outlined by 54. In this manner, the tank can remain within the exterior sheet metal housing thus keeping the machine footprint size at a minimum. Also, a cutout area 56 of the column 22 may be included at an area of the column remote from the spindles for placement of any necessary electrical transformers. With this arrangement, such electrical components can also stay within the exterior sheet metal enclosure and yet be spaced far enough from the spindles such that heat radiating from the electrical components will not adversely influence the accuracy of the spindles or other tolerance sensitive elements.

The present invention provides a compound holding tank and a magnetic filtration device which address the deficiencies noted above.

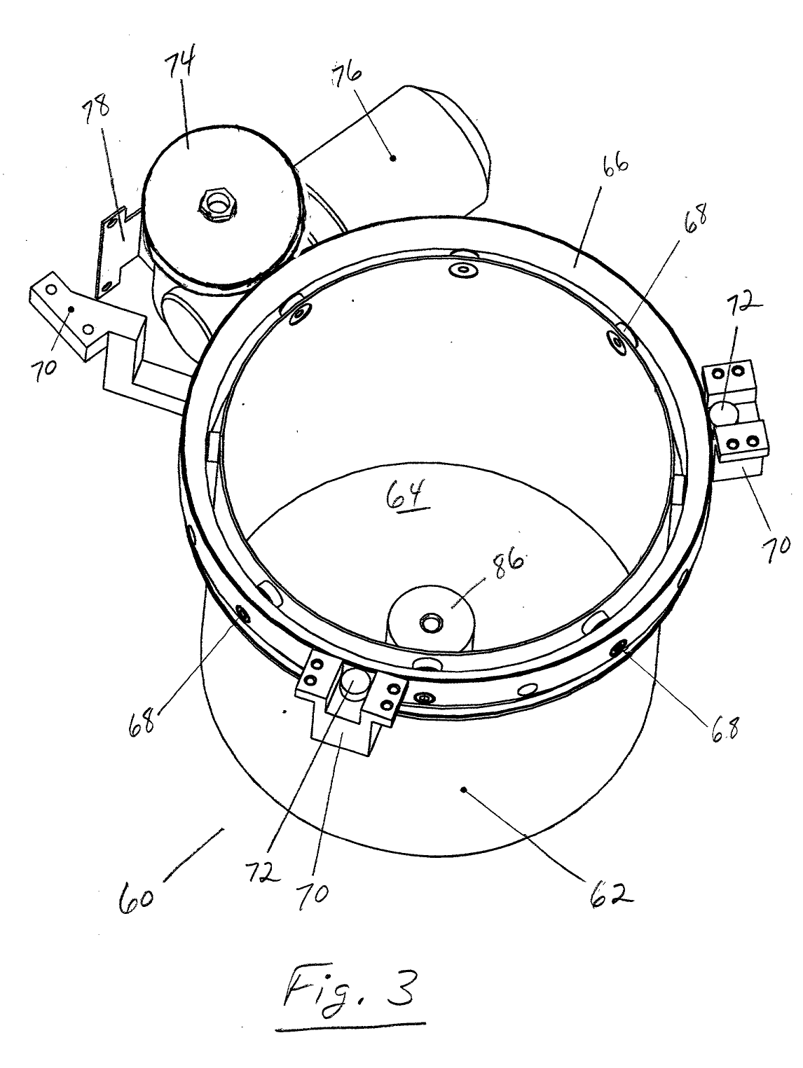

FIG. 3 illustrates the inventive compound holding and mixing tank 60 comprising a cylindrical side 62 and a flat bottom 64. Preferably, the tank 60 is positioned at least partially below the lapping chamber of a lapping machine. A pump (not shown) of any suitable type is employed to draw lapping compound, not from a drain hole in the tank bottom, but up and out through a pipe that extends down into the tank from the top. The compound passes first through a magnetic filtration device, discussed below, then through the pump itself and is delivered to the lapping chamber and the gears being lapped. Preferably, the lapping chamber includes a sloped bottom so that the lapping compound can be collected and drained directly through an opening into the tank below.

The cylindrical tank 60 is attached near its top to a support ring 66 via a plurality of standoff screws 68 in such a way that if the lapping compound were to overflow the tank 60, it would drain down the outside of the tank with little possibility of contaminating the bearing surfaces of the ring 66. The tank 60 and ring 66 are preferably supported by three generally equidistantly spaced brackets 70 each of which is attached to the sloped bottom of the lapping chamber thereby allowing the tank to be located under the lapping chamber. The brackets 70 each include a vertically-oriented needle bearing roller (not shown) that rides against a horizontal surface of the ring 66 to support the weight of the tank 60.

Three generally equidistantly spaced horizontally-oriented rollers ride against a vertical surface of the ring 66 and locate the tank 60 and allow the tank to turn about its axis. Two of the horizontally-oriented rollers are shown at 72 and the other horizontal roller is a large diameter wheel 74 driven by a motor 76 that is also attached to the machine via a bracket 78. Motor 76 is capable of generating sufficient friction between wheel 74 and the driven ring 66 to effect rotation of the tank 60. A spring and pivot system (not shown) holds the driving wheel against the ring 66 with a known force, and can accommodate small circularity errors of the driven ring 66, the wheel 74 or the other rollers 72, without the loss of contact or driving force.

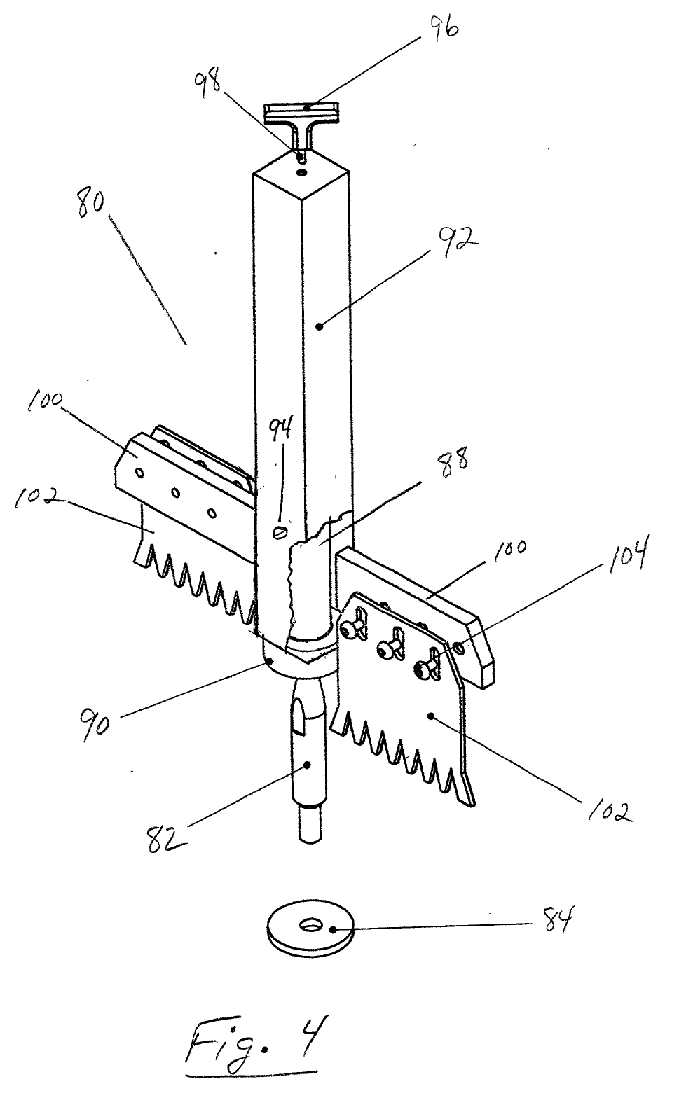

FIG. 4 illustrates the mixer and scraper assembly 80 which is inserted into tank 60 from above and is piloted on a pivot pin 82 and washer 84 (or other equivalent means) insertable into a receiving bore 86 in the center inside of the tank. The mixer and scraper assembly 80 comprises an internal shaft 88 attached at its lower end to spacer ring 90. Pivot pin 82 is also pivotally attached to spacer ring 90. Arranged about shaft 88 is housing 92 which is fixed to shaft 88 by one or more screws 94 only one of which is shown. Housing 92 includes a handle 96 attached to its top end by means such as screw 98. Attached to housing 92 are a pair of opposed support arms 100 made of weldable steel having a thickness preferably about 0.5 inch (12.7 mm). Scraper blades 102 are secured to each support arm 100 by a plurality of screws 104. Scraper blades 102 are made from any strong and durable material such as sheet steel having a thickness of about 0.150 inch (3.81 mm).

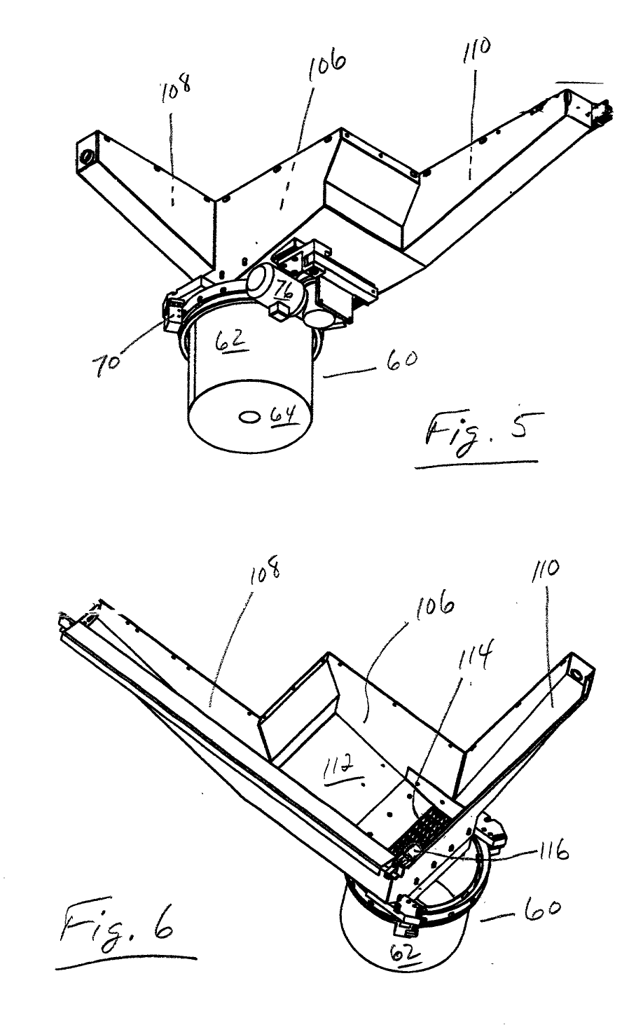

FIGS. 5 and 6 illustrate the inventive mixing tank 60 positioned below the bottom portion 106 of the lapping chamber of a lapping machine. The bottom portion 106 may include sloped troughs 108 and 110 which reside under the doors of the lapping machine to catch compound draining from the inside of the doors and direct it into the bottom portion 106. As is best seen in FIG. 6, bottom portion 106 includes a sloped bottom surface 112 which directs compound to screen 114 where it drains back into tank 60.

Screen 114 includes a cut-out portion 116 having the same cross-sectional shape as housing 92. When tank 60 and the mixer and scraper assembly 80 are secured to bottom portion 106, housing 92 is inserted through cut-out portion 116. In doing so, rotation of housing 92, as well as scraper blades 102 is prevented during rotation of tank 60. Although positioned in tank bottom 64, mixer and scraper assembly 80 can remain still during rotation of tank 60 because of the presence of pivot pin 82.

The advantages of the configuration described above include the efficient use of floor space since the tank occupies much of the same area as the lapping chamber of the machine. There are fewer potential accumulation surfaces between the lapping chamber drain and the tank 60. Cost and complexity of the tank 60 is reduced since it is a simple flat-bottomed cylinder with no fittings in the sides or bottom.

In order to “mix” or maintain the grit in suspension, the cylindrical tank 60 is rotated by the wheel 74 in contact with ring 66. The purpose of the mixer and scraper assembly 80 is not to introduce great turbulence throughout the whole volume of the tank, but rather to provide strong small-scale turbulence or even scraping action very close to the bottom 64 of the tank 60. Recirculation is used in conjunction with the mixing to provide homogeneity of the mixture throughout the whole volume of compound.

The tank 60 is rotated relatively slowly, compared to the aforementioned agitation techniques. For example, a 0.25 horsepower motor, geared for 15 RPM rather than 90 RPM, can produce four times the torque on the blades 102. The blades 102 keep a low profile when viewed vertically (i.e. there is little, if any, twist to the blades) which minimizes the ability of sediments to cement the blades to the bottom of the tank and prevent them from being removed.

Since the holding tank 60 is comprised only of a vertical wall 62 and a flat bottom 64, the only accumulation point is the flat bottom 64. The scraping blades 102 are positioned very close to, preferably on the order of about 0.25 inch, but not touching the tank bottom 64. Scraper blades 102 can have a flat, toothed, serrated or otherwise patterned edge. As tank 60 rotates, the whole bottom 64 of the tank passes very close to the scraper blades and the high torques available and small-scale turbulence localized near the edge of the scraper blades prevent the thickening and accumulation of sediments. Once these potential sediments are broken up, the bottom passes close underneath the suction pipe which draws the compound from this richest part of the tank and recirculates it through a filter, a pump, and an optional in-line heater, and returns it to the tank 60. The suction pipe, preferably located to the side of the tank 60, comes in close proximity to a large proportion of the tank bottom as the tank turns beneath the pipe.

If the machine sits unused for a period of time and significant sedimentation or even cementation does occur, the inventive mixing system is still effective at breaking up the accumulation and restoring it to circulation. The mixing system generates much greater torques that allow most sediments to be broken up with normal operation. If, however, the motor 76 cannot overcome the holding force, the condition is detected by a tank motion detector (not shown). The operator is prompted to lift the mixer and scraper assembly 80 a few inches vertically using the handle 96. Once lifted clear of the sediments, the motor 76 can be started again since no restraining force exists any longer. The mixer and scraper assembly 80 has the freedom on its support and pilot 82 to move axially, and the operator can set it back down on top of the rotating accumulated sediments. The weight of the assembly 80 itself is sufficient to slowly drive the scraper blades 102 back into the cemented sediment over the course of many rotations, scraping and returning the grit to suspension.

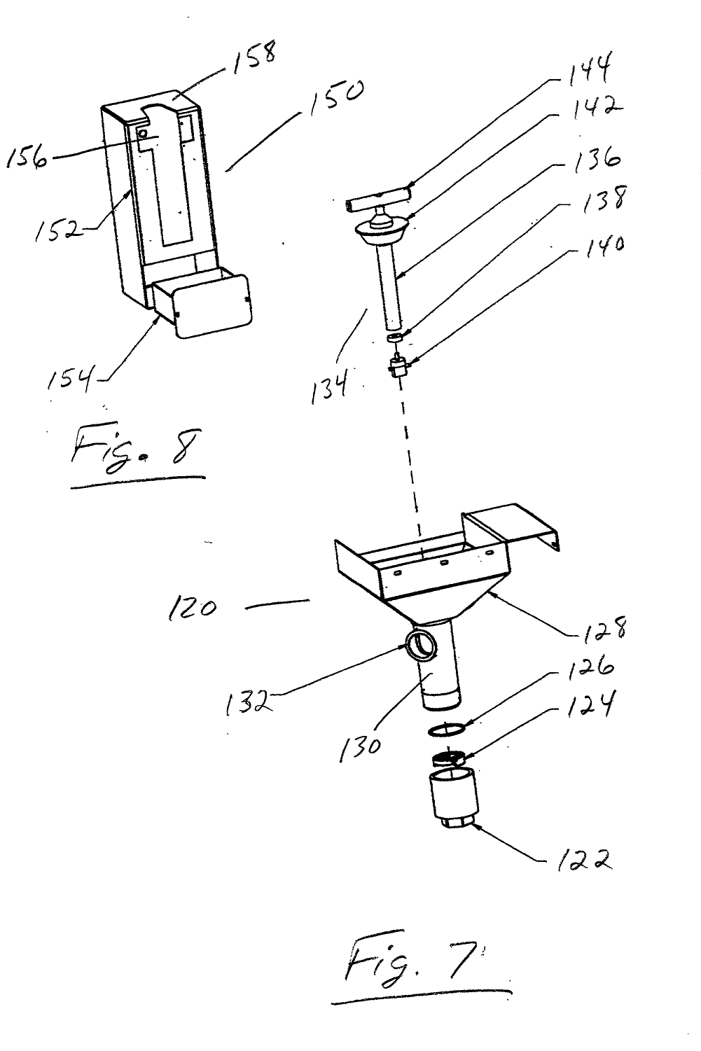

The present invention also includes an in-line compound filtration system 120 as shown in FIG. 7. The filtration system comprises an inlet section 122, filter screen 124, seal 126, funnel portion 128 having a tubular portion 130 and an outlet 132, and a magnetic unit 134. Magnetic unit 134 includes a cylindrical magnet 136 (for example, a rare earth magnet), a trim spacer 138 and locking pin 140 at one end and a tapered seal 142 and a handle 144 at its other end. The magnetic unit 134 is positioned in the funnel section 128 so that magnet 136 resides in the tubular section formed by tubular portion 130 and inlet section 122. Preferably, about 0.375 inch clearance exists between the magnet 136 and the inside surface of the tubular portion 130 and inlet section 122. Magnet 136 is held in place by pin 140 locking via a camming action in filter screen 124. Lapping compound enters inlet section 122, passes along the magnet 136 where any entrained metal particles are deposited, and exits via outlet 132.

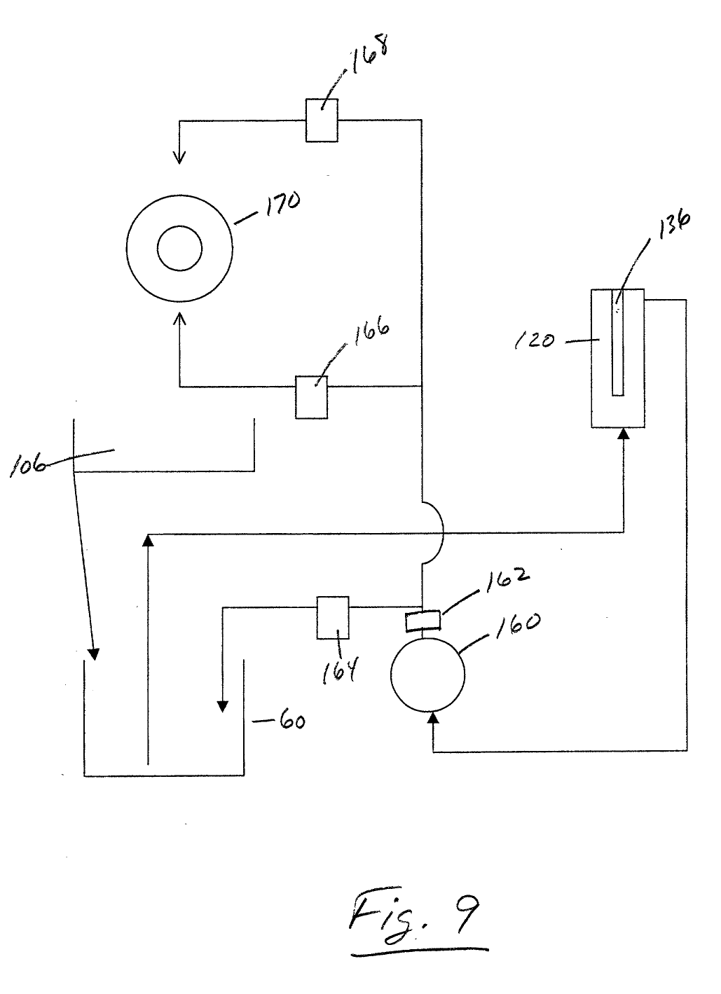

The magnet 136 is cleaned by periodically removing the magnetic unit 134 from the funnel 128 and placing it in a remotely located cleaning unit 150 as shown in FIG. 8. Cleaning unit 150 comprises a sludge container 152 and a sludge drawer 154 removably insertable into the bottom of sludge container 152. Magnetic unit 134 is placed into sludge container 152 so that tapered seal 142 and magnet 136 passes through opening 156 into sludge container 152. Once inside container 152, the operator pulls handle 144 in a direction away from the top 158 of container 152 thereby causing magnet 136 to slide through tapered seal 142 with pin 140 functioning as a stop mechanism to maintain seal 142 in place on magnet 136. Thus, seal 142 scrapes any metal particles from magnet 136 which are deposited in sludge drawer 154. Once magnet 136 is cleaned, the operator pushes handle 144 toward surface 158 to return the magnet 136 to its sealing position adjacent handle 144.

The magnetic filter unit 120 has the advantage that the magnet 136 can be cleaned without dirtying the hands of the operator. The tapered seal 142 is preferably made from synthetic rubber (or equivalent or similar material) and functions to both seal and clean the magnet 136. The magnetic unit 134 is located in the suction section of the compound system piping so the pump action itself assists to draw the rubber seal 142 in the funnel portion 128. Furthermore, magnet 136 is locked into position with camming action of only about a quarter turn. Also, all compound is forced to travel a significant distance (e.g. about 5 inches (127 mm)) within a short distance (e.g. 0.375 inch (9.53 mm)) of the magnet 136. No tools are needed to perform this cleaning function.

As an example, FIG. 9 diagrammatically illustrates a lapping compound circulation system. Lapping compound flows from tank 60 to magnetic filter 120 and on to pump 160. If desired, an inline heater 162 may be placed after pump 160. The system comprises three valves 164, 166 and 168 which control the direction of flow. If compound is to be directed to a gearset, valve 164 is closed and either of valves 166 or 168 is opened depending on the direction of rotation of the gears 170. Lapping compound then falls into bottom portion 106 and drains back into tank 60. If lapping compound is to be recirculated, such as when no lapping is taking place, valves 166 and 168 are closed and valve 164 is opened to return compound to tank 60.

While the invention has been described with reference to preferred embodiments it is to be understood that the invention is not limited to the particulars thereof. The present invention is intended to include modifications which would be apparent to those skilled in the art to which the subject matter pertains without deviating from the spirit and scope of the appended claims.

What is claimed is:

1. An in-line filtration unit comprising:
a conduit having a length, said conduit comprising an inlet and an outlet spaced from said inlet along said length,
a magnetic unit removably positioned in said conduit along at least a portion of said length,
wherein material containing undesirable entrained particles enters said inlet, passes through said conduit and about said magnetic unit and exits said outlet, said undesirable entrained particles being attracted to said magnetic unit and thereby being removed from said material.

2. The filtration unit of claim 1 wherein said conduit further comprises:
first and second openings located at respective ends of said length with said first opening being said inlet and said second opening receiving said magnetic unit for positioning in said conduit,
said outlet being located in said conduit between said inlet and said second opening.

3. The filtration unit of claim 2 wherein said magnetic unit further comprises sealing means whereby when said magnetic unit is positioned in said conduit, said sealing means closes said second end.

4. The filtration unit of claim 1 wherein said sealing means is located positioned about said magnetic unit and wherein said magnetic unit is movable relative to said sealing means whereby movement of said magnetic unit relative to said sealing means effects a wiping-off of any said undesirable particles from said magnetic means.

5. The filtration unit of claim 1 wherein said magnetic unit comprises a generally elongate form having first and second ends, said second end being adjacent a handle for inserting and/or removing said magnetic unit from said conduit.

6. The filtration unit of claim 5 wherein said sealing means is located positioned about said magnetic unit adjacent said handle and wherein said magnetic unit is movable relative to said sealing means whereby movement of said magnetic unit relative to said sealing means effects a wiping-off of any said undesirable particles from said magnetic means.

7. The filtration unit of claim 1 wherein said magnetic unit comprises a generally elongate form having first and second ends, said first end comprising a locking means for removably securing said magnetic unit in said conduit.

8. The filtration unit of claim 1 wherein said conduit is of a generally cylindrical tube form having an inner diameter and said magnetic unit is of a generally cylindrical form having an outer diameter, said outer diameter being less than said inner diameter whereby a predetermined clearance is formed between said conduit and said magnetic unit such that said material having entrained undesirable particles passes within a predetermined distance of said magnetic unit.

9. The filtration unit of claim 1 wherein said filtration unit is positioned on a machine for lapping gears.

10. A magnetic unit for insertion into an in-line filtration unit, said magnetic unit comprising:
a generally elongate body having first and second ends,
wiping-off means located adjacent one of said first and second ends with said wiping-off means being located positioned about said magnetic unit and wherein said magnetic unit is movable relative to said wiping-off means whereby movement of said magnetic unit relative to said wiping-off means effects a wiping-off of any particles attracted by and adhered to said magnetic means.

11. The combination of a magnetic unit and a cleaning unit, said combination comprising:
said magnetic unit having a generally elongate body having first and second ends,
wiping-off means located adjacent one of said first and second ends with said wiping-off means being located positioned about said magnetic unit and wherein said magnetic unit is movable relative to said wiping-off means whereby movement of said magnetic unit relative to said wiping-off means effects a wiping-off of any particles attracted by and adhered to said magnetic means,
said cleaning unit comprising a container portion and a collection portion, said container portion being shaped so as to allow placement of said magnetic unit within said container portion, said container portion further comprising means to permit movement of said magnetic unit relative to said wiping-off means whereby any particles attracted by and adhered to said magnetic means are removed from said magnetic unit to said collection portion.

12. A holding and mixing tank for lapping compound, said tank comprising:
a tank bottom and a generally cylindrical side portion, said tank having an axis of rotation and being rotatable about said axis of rotation,
means to rotate said tank,
a mixer and scraper assembly pivotally positioned in said tank adjacent said tank bottom,
means to prevent rotation of said mixer and scraper assembly upon rotation of said tank.

13. A machine for lapping gears, said machine comprising:
a holding and mixing tank for lapping compound, said tank comprising a tank bottom and a generally cylindrical side portion, said tank having an axis of rotation and being rotatable about said axis of rotation, means to rotate said tank, a mixer and scraper assembly pivotally positioned in said tank adjacent said tank bottom, and means to prevent rotation of said mixer and scraper assembly upon rotation of said tank, and,
an in-line filtration unit comprising a conduit having a length, said conduit comprising an inlet and an outlet spaced from said inlet along said length, a magnetic unit removably positioned in said conduit along at least a portion of said length, wherein material containing undesirable entrained particles enters said inlet, passes through said conduit and about said magnetic unit and exits said outlet, said undesirable entrained particles being attracted to said magnetic unit and thereby being removed from said material.
